(19) United States
(12) Patent Application Publication
(10) Pub. No.: US 2009/0271767 A1
(43) Pub. Date: Oct. 29, 2009

(54) Method and an apparatus for evaluating a tool

(76) Inventors: Rudiger Bertsch, Erlangen (DE); Kristian Dencovski, Erlangen (DE); Timo Holm, Numberg (DE); Mathias Maurmaier, Gerlingen (DE); Erich Mikk, Erlangen (DE); Thomas Wagner, Bubenreuth (DE)

Correspondence Address: HARNESS, DICKEY & PIERCE, P.L.C., P.O. BOX 8910, RESTON, VA, 20195, US

(21) Appl. No.: 12/320,159

(22) Filed: Jan. 21, 2009

(30) Foreign Application Priority Data
Apr. 23, 2008 (EP) 08 007 873.6

(51) Int. Cl. G06F 9/44

(52) U.S. Cl. 717/124

(57) ABSTRACT

A method is disclosed for evaluating a tool used in a system including steps of providing top-level-challenges to be met by the tool in at least one life cycle phase of the system to enhance a productivity of the given system. In at least one embodiment, each top-level-challenge can be provided, each having a number of concepts or best practices with different numeric classification values. At least one tool profile of the tool is calculated for selected top-level-challenges by way of a function as a statistical function on the basis of numeric classification values assigned to sub-challenges of the top-level-challenges. The method and apparatus according to at least one embodiment of the present invention can be used for evaluating a software tool such as a service information system employed in an industrial system such as a power plant for one or several life cycle phases of the system including its engineering, commissioning, operation, service and modernization phase. The method and apparatus according to at least one embodiment of the present invention can maximize the productivity of a given system and offers a tool supplier a possibility to optimize its tools.

### PRIORITY

This application claims priority of EP application 08 007 873.6 filed on Apr. 23, 2008 the content of which is herewith incorporated by reference in its entirety.

### FIELD

Embodiments of the present invention generally relate to a method and/or an apparatus for evaluating a tool used in a system, and more particularly to a method and/or an apparatus for evaluating a software information tool used in an industrial system having a life cycle including several life cycle phases.

### BACKGROUND

Systems such as industrial systems can often be very complex comprising a plurality of components of different subdomains, for example in the electrical, mechanical automation or civil engineering subdomain. For example for planning an operation as well as maintenance and modernization of a power plant a plurality of tools, in particular software information tools are employed by different users working in different subdomains. Each system has a system life cycle consisting of several life cycle phases such as a design and engineering of the system, installation and commissioning of the system, operation of the system, service and maintenance of the system as well as modernisation of the respective system. Each life cycle phase of such a system can use different tools in particular different software tools can be employed by users to perform the necessary tasks. Some software tools are especially designed for a specific life cycle phase whereas other software tools can be used in different life cycle phases of the respective system. For example a word processing tool such as WORD can be used in several life cycle phases of a system whereas a graphical design tool is used mostly in a design and engineering phase of a system.

The use of high performance software tools increases the performance and productivity of facilities, devices, arrangements and entities of a system.

Before using a software tool it has to be checked whether the respective software tool actually meets requirements set out for this software tool or being expected by the users from this software tool. For example it may be expected that a software tool performs certain tasks with regard to specifying, configuring or controlling a unit of an industrial system in a specific life cycle phase of the system. Moreover, it has to be ensured that the tasks performed by the software tool are performed in an efficient way. Therefore, a possibility of checking whether a software tool has the required properties is useful.

There can always be further requirements for a software tool or further proposals for improving the respective software tool which are raised for example during the time of utilization or operation of the software tool.

In view of possible alternative software tool developments there is further a need for a possibility of comparing alternative software tools for example with regard to their intrinsic concepts.

To satisfy the above requirements or needs in conventional software systems evaluation there are employed methodologies which address evaluation criteria such as quality, e.g. ergonomics, of the respective software tool.

However, conventional tool evaluation methodologies use subjective expert description of the respective software tool when performing an evaluation of the tool. Thus, the results provided by such known methodologies have only a subjective nature. Furthermore, conventional tool evaluation methodologies which are employed to evaluate tools of a system, perform the evaluation of the software mostly from generic, domain-independent point of view, such as Reliability, Usability, Maintainability and Portability which do not reflect the point of view of experts working in a specific domain of the system and in a specific life cycle phase of the system.

Conventional evaluation methodologies can not address interdisciplinary challenges to enhance the productivity of the system.

### SUMMARY

At least one embodiment of the present invention provides a method and/or an apparatus for evaluating a tool used in a system in an objective manner considering information and expertise of different domains and different life cycle phases to enhance a productivity of the system.

At least one embodiment is directed to a method for evaluating a tool used in a system comprising the steps of:

providing top-level-challenges TLC to be met by the tool in at least one life cycle phase of the system to enhance a productivity of the system,
wherein each top-level-challenge TLC comprises sub-challenges SLC each having a predetermined number of concepts with different numeric classification values; and calculating at least one tool profile of the tool for the top-level-challenges TLC by way of a predetermined function on the basis of numeric classification values assigned to the sub-challenges SLC of the top-level-challenges.

In an embodiment of the method according to the present invention the numeric classification values are formed by integer values which are assigned to the sub-challenges SLC on the basis of concepts provided by the tool or on the basis of concepts of the tool actually used by a user.

In an embodiment of the method according to the present invention the function is formed by a statistical function of the numeric classification values.

In an embodiment of the method according to the present invention the statistical function is calculating an average value on the basis of the numeric classification values.

In an embodiment of the method according to the present invention at least one further tool profile of the same or another tool is calculated and a profile difference between the calculated tool profiles is determined by comparing the tool profiles.

In an embodiment of the method according to the present invention the numeric classification values are assigned using a reference tool architecture of the tool stored in a data base.

In an embodiment of the method according to the present invention the tool is formed by a software information tool.

In an embodiment of the method according to the present invention the tool is formed by a hardware too,

In an embodiment of the method according to the present invention the system is formed by an industrial system comprising as a life cycle phases:

an engineering phase,
a commissioning phase,
an operation phase,
a service phase, and
a modernization phase.

In an embodiment of the method according to the present invention for each life cycle phase of the system at least one top-level challenge is stored in a data base.

In an embodiment of the method according to the present invention a group of top-level-challenges to be met by the tool is selected from top-level-challenges stored in a data base.

In an embodiment of the method according to the present invention at least one tool used in the system is controlled in response to a determined profile difference.

In an embodiment of the method according to the present invention the tool profile is calculated on the basis of a tool requirement specification, a tool design specification, a tool protocol type specification or a tool release specification.

In an embodiment of the method according to the present invention the method is performed by executing instructions of a computer program stored on a data carrier.

At least one embodiment of the invention further provides an apparatus for evaluating a tool used in a system, the apparatus comprising:

means for providing top-level-challenges to be met by the tool in at least one life cycle phase of the system to enhance a productivity of the system,
wherein each top-level-challenge comprises sub-challenges each having a predetermined number of concepts with different numeric classification values; and
means for calculating at least one tool profile of the tool for top-level-challenges by way of a predetermined function on the basis of numeric classification values assigned to the sub-challenges of the top-level-challenges.

At least one embodiment of the invention further provides an apparatus for evaluation a tool used in a system the apparatus comprising:

a database which stores top-level-challenges of life cycle phases of the system, wherein each top-level-challenge comprises sub-challenges each having a predetermined number of concepts with different numeric classification values; and a processor which calculates at least one tool profile of the tool for selected top-level-challenges by way of a predetermined function on the basis of numeric classification values assigned to sub-challenges of the selected top-level-challenges.

In an embodiment of the apparatus according to the present invention the apparatus further comprises a user interface for selecting of top-level-challenges and assigning numeric classification values and for displaying the at least one calculated tool profile.

In an embodiment of the apparatus according to the present invention the apparatus further comprises a configuration interface for configuration of the function used by the processor for calculating the tool profile.

At least one embodiment of the invention further provides a system having a system life cycle consisting of at least one life cycle phase and using at least one tool in one of the life cycle phases,

wherein for each life cycle phase at least one top-level-challenge is stored in a data base, each top-level-challenge comprising sub-challenges each having a predetermined number of concepts with different numeric classification values which are assigned to the respective sub-challenges for calculation of tool profiles to evaluate tools used in one or more life cycle phases of the system.

In an embodiment of the system according to the present invention the system comprises an industrial system as a maindomain having several subdomains.

In an embodiment of the system according to the present invention the subdomain comprises an electrical subdomain, a mechanical subdomain, an automation subdomain and a civil engineering subdomain.

### BRIEF DESCRIPTION OF THE DRAWINGS

The present invention will be understood more clearly from the following description of embodiments of the invention in conjunction with the attached drawings in which:

FIG. 1 shows life cycle phases of a life cycle of an system using tools which can be evaluated by a method and apparatus according to an embodiment of the present invention;

FIG. 2 shows an example hierarchy of challenges to be met by a tool and employed by the method and apparatus according to an embodiment of the present invention;

FIG. 3 shows a meta model as employed in an example embodiment by the method and apparatus according to an embodiment of the present invention;

FIG. 4 shows an example table for an assignment of numeric classification values for different sub-challenges of a top-level-challenge as employed by a method and apparatus according to an embodiment of the present invention;

FIG. 5 shows a flow chart of an example embodiment of a method for evaluating a tool used in a system according to an embodiment of the present invention;

FIG. 6 shows a block diagram of an example embodiment of an apparatus for evaluating a tool used in a system according to an embodiment of the present invention;

FIG. 7 shows an example evaluation workflow for illustrating the method according to an embodiment of the present invention;

FIG. 8 shows an example of displayed tool profiles with respect to several top-level-challenges of a tool employed during a life cycle phase of a system according to an embodiment of the present invention;

FIG. 9 shows a further example of a displayed tool profile of a tool employed in different life cycle phases of a system;

FIG. 10 shows a diagram of a reference tool architecture which can be employed in an example embodiment of the method according to an embodiment of the present invention.

### DETAILED DESCRIPTION OF EXAMPLE EMBODIMENTS

In the following some embodiments of the method and the apparatus according to the present invention are described with reference to the enclosed figures.

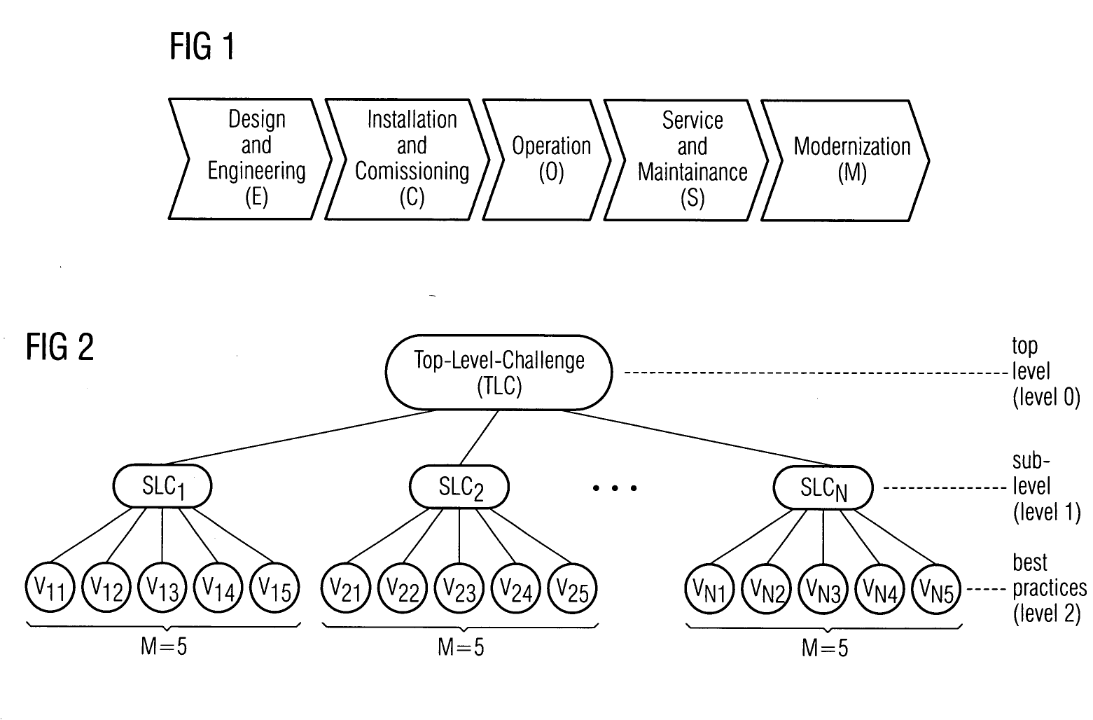

As can be seen from FIG. 1 a system such as a technical system, for example a power plant, comprises a life cycle including life cycle phases. These life cycle phases can comprise a design and engineering phase, an installation and commissioning phase, an operation phase, a service and maintenance phase as well as a modernization phase. Each life cycle phase has one or more top-level-challenges to be met by a software tool as defined and stored in a data base. The provided top-level-challenges (TCL) have to be met to enhance a productivity of the system.

In the engineering phase of a system such as a power plant the plant is designed by experts of various crafts or domains. The domains can comprise for example an electrical, a mechanical, an automation or a civil engineering domain. The engineering can provide a specification of all technical aspects of the respective system, i.e. for example an industrial power plant. The engineering life cycle phase can include for example activities or tasks concerning the selection of hardware or software components and determining of control functions and device parameters of the different hard- or software components employed in entities or units of the technical system.

After completion of the design and engineering phase the industrial system is commissioned for the customer. For the installation of the system a timing can be scheduled and based on hardware implementation plans generated for example in the engineering phase such as assembly or mounting documents, e.g. cable lists, material lists or job orders. Process parameters of the respective systems can be optimized.

After commissioning an installation of the system the respective system can be put into operation. In the operation phase the responsibility for the respective system such as a power plant is moved from the manufacturer of the system or plant to the operator of the system. During operation of the system an operation with as few interruptions as possible has the highest priority.

During the maintenance or service phase basic operations such as maintenance, inspection, repair and improvement of components within the system are performed. The maintenance and service phase includes in the context of an industrial system or industrial installations all measures required for the conservation or re-establishment of a functional status. The maintenance or service phase includes tasks like ensuring the performance of a technical process within the system while there is an ongoing optimization with regard to an availability of the respective system and a planning of maintenance concepts.

The last life cycle phase of a system as shown in FIG. 1 refers to a modernization and an upgrade phase. If the performance of a system such as a plant is not up-to-date, an upgrading and a modernization of the system has to be performed.

During the different life cycle phases of a technical system such as an industrial plant different software tools and hardware tools can be used. Some software tools are used only within a specific life cycle phase. Other software tools can be used for several life cycle phases of the system. An effective increase of the productivity of the system is achieved only if the used industrial software and hardware tools provide an optimal behaviour in the whole work-flow over the complete life cycle of the respective technical system.

In the method and evaluation system according to an embodiment of the present invention, a database is used that stores top-level challenges of one or several life cycle phases of the respective system such as a power plant comprising software or hardware tools to be evaluated. Each life cycle phase of the life cycle phases as shown in FIG. 1 can comprise one or several top-level challenges TLC to be met by the respective tool to be evaluated enhancing the productivity of the whole system. To each life cycle phase, corresponding top-level challenges TLC can be assigned. Accordingly, there are engineering top-level-challenges E-TLC, installation and commissioning top-level-challenges C-TLC, operation top-level-challenges O-TLC, service and maintenance top-level-challenges S-TLC as well as modernization top-level-challenges M-TLC to be met by the tool to optimize the productivity of the industrial system.

In an embodiment of the method and apparatus according to the present invention, each top-level-challenge TLC can be stored in a database each comprising variable numbers of sub-level-challenges SLC as shown in the diagram of FIG. 2. Every sub-level-challenge SLC can describe a single determinant on the efficiency of support offered by a tool in achieving an optimization of the respective industrial system. For every sub-level challenge SLC, a predetermined number of concepts, i.e. best practices with different numeric classification values v is provided.

In the example shown in FIG. 2, each sub-level challenge SLC has M=5 numeric classification values v indicating five different best practices or concepts to reflect the corresponding determinant indicating the extent of support offered by the respective tool. For example, the numeric classification value v can be formed by an integer value assigned as best practice to the respective sub-level-challenge SLC indicating whether the respective tool to be evaluated offers no support (v=0), only an implicit support (v=1), an explicit support, however limited (v=2), an explicit extensive support (v=3) or even a generic support (v=4). For each sub-level-challenge SLC, a best practice classification value v is assigned and stored in a memory or a database.

Each top-level challenge TLC forms a productivity factor influencing the productivity of the respective industrial system as the main domain. In summary, each top-level-challenge TLC comprises at least one sub-level challenge SCL indicating a productivity-relevant tool feature to be fulfilled by a tool, in particular by an software tool used by the system. Each sub-level-challenge SLC has a predetermined fixed number of concepts as illustrated by the tree structure of FIG. 2 with different numeric classification values v indicating how powerfully or effectively the respective software tool supports the user in achieving the respective top-level-challenge TLC.

On the basis of the numeric classification values v assigned to the sub-level-challenges SLC of the top-level-challenges TLC in the database the method according to an embodiment of the present invention calculates at least one tool profile for selected top-level-challenges TLC on the basis of a predetermined function.

In an example embodiment, specific top-level-challenges TLC, are selected from a set of top-level-challenges stored in a database. For the selected top-level-challenges TLC, one or several tool profiles for the respective to be evaluated tool are calculated by way of a predetermined function which can be formed by a statistical function. In an example embodiment, the statistical function calculates an average value on the basis of the assigned numeric classification values v. In an example embodiment, the used function is configurable. The tool profiles of the evaluated tool can be displayed to a user, for example as a kiviat graph or a radar chart.

In an example embodiment, the numeric classification values v are formed by integer values which are assigned to the sub-level-challenges SLC on the basis of concepts provided by the respective tool. In this case, the calculated tool profile is based on all features offered by the respective tool.

Furthermore, it is possible that the numeric classification values v are assigned to the sub-level-challenges SLC on the basis of concepts provided by the respective tool, but only on the basis of concepts of the respective tool actually used by a user. In this case a usage profile is generated.

For each tool to be evaluated tool profiles or usage profiles can be calculated. In an example embodiment, at least one further tool profile of the same or another tool is calculated and a profile difference between the calculated tool profiles is determined by comparing the calculated tool profiles.

In an example embodiment, the numeric classification values v are assigned using a reference tool architecture of the respective tool stored in a database.

The tools evaluated by the method according to an embodiment of the present invention can be any kind or type of tool used in a technical system, in particular a software tool. These software tools can comprise software information tools. Examples for software tools during different life cycle phases of a system are common software tools such as table sheet programs (e.g. Excel), word processing programs (e.g. WORD), graphic design tools (e.g. AUTOCAD) or life cycle management tools (e.g. COMOS). The assignment of the numeric classification values v can be performed in an example embodiment automatically.

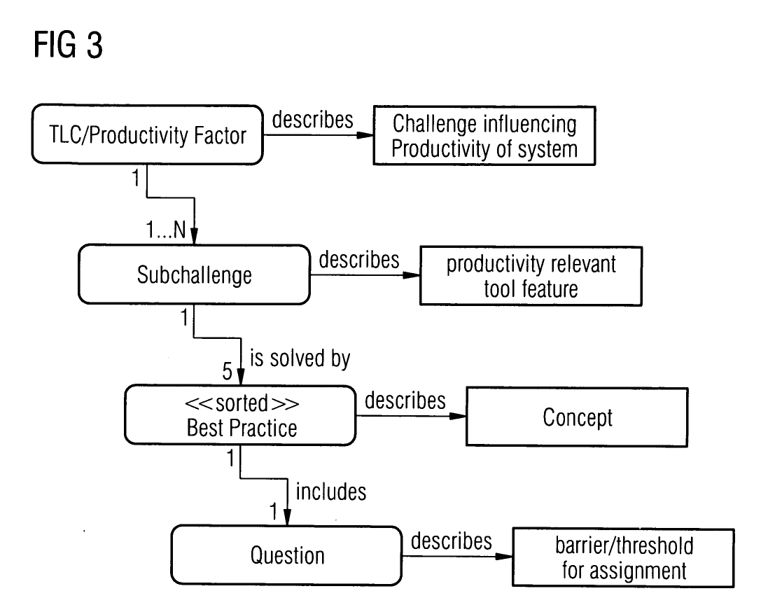

FIG. 3 shows a meta model as employed in an example embodiment of the method and apparatus according to an embodiment of the present invention. The top-level-challenge TLC forming a productivity factor influencing the productivity of the system can comprise N sub-challenges SLC describing each a productivity relevant tool feature. This sub-challenges are solved by best practices describing concepts provided to address the respective sub-challenge SLC. To avoid any subjective aspect during the evaluation of the respective tool a challenge structured according to the meta model shown in FIG. 3 can be associated to a reference architecture.

In an example embodiment as shown in the meta model of FIG. 3 for each best practice or key concept a corresponding question can be provided which is stored in the data base forming a barrier or a threshold for the numeric classification values v assigned to a sub-level-challenge SLC.

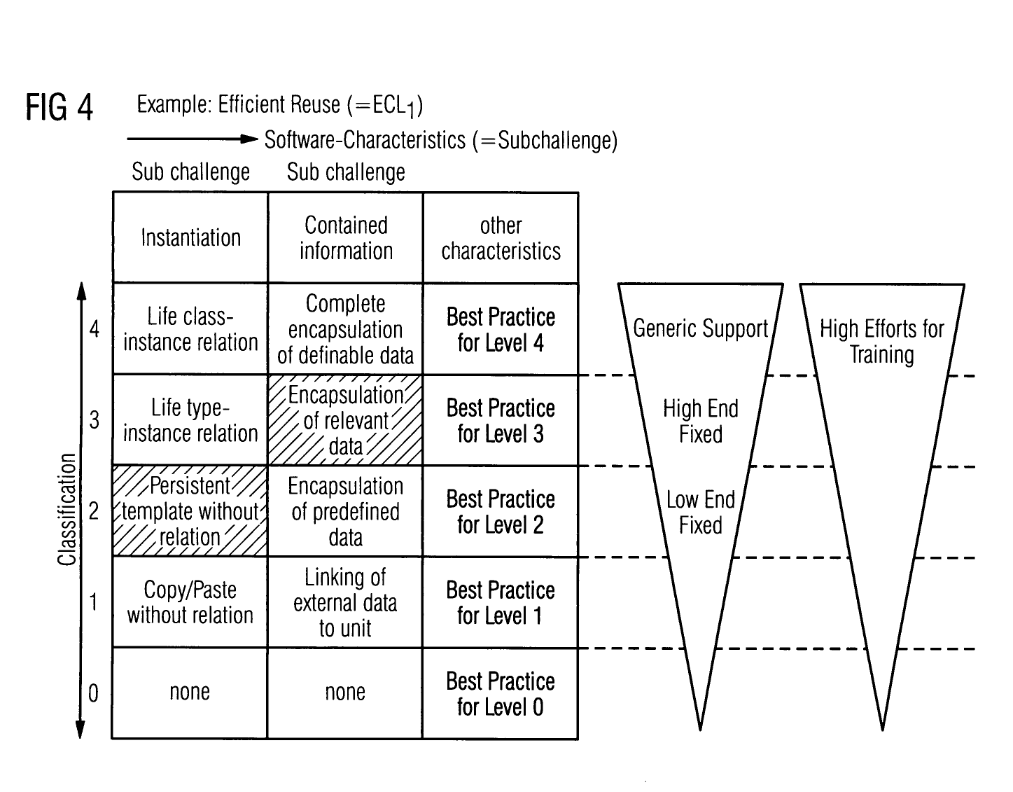

FIG. 4 shows a diagram for illustrating the assignment of numeric classification values v as best-practices to sub-level-challenges SLC. In the given example a top-level-challenge TLC “efficient reuse” of the engineering life cycle phase (E) comprises several sub-challenges or sub-level-challenges SLC such as “instantiation” and “contained information”. Further sub-challenges SLC of the shown top-level-challenge “efficient reuse” are possible. In the given example for the best practices several classification levels zero to four are provided. In the given example the concept or best practice “persistent template without a relation” comprising a numeric classification value of (v=2) is assigned to the subchallenge “instantiation” whereas a best practice “encapsulation of relevant data” is assigned to the second subchallenge “contained information” of the top-level-challenge “efficient reuse”. On the basis of the assigned numeric classification values a function value can be calculated representing the top-level-challenge “efficient reuse”. This function value can be formed for example by a function calculating an average of the selected or assigned numeric classification values vᵢ. In the given example of FIG. 4 if the top-level-challenge “efficient reuse” of the engineering life cycle phase of the system comprises two sub-challenges “instantiation” and “contained information” and the best practice “persistence template without relation” is selected for the first sub-challenge SLC1 and the best practice “encapsulation of relevant data” is selected for the second sub-challenge SLC2 the average value calculated by way of a statistical average function is e.g. (2+3)/2=2, 5 indicating a characteristic value of the respective top-level-challenge “efficient reuse” being a measure of the extent of support offered by the respective tool to be evaluated in achieving the top-level-challenge “efficient reuse” in the engineering life cycle phase of the respective industrial system. The classified best practices as shown in FIG. 4 form a basis for comparability and measurability of the support offered by tools employed in the system to enhance the productivity in the system. By performing an assignment of numeric classification values v and evaluating a characteristic value for each selected top-level-challenge TLC to be met by the evaluated tool a characteristic tool profile can be calculated and displayed on a display as a diagram.

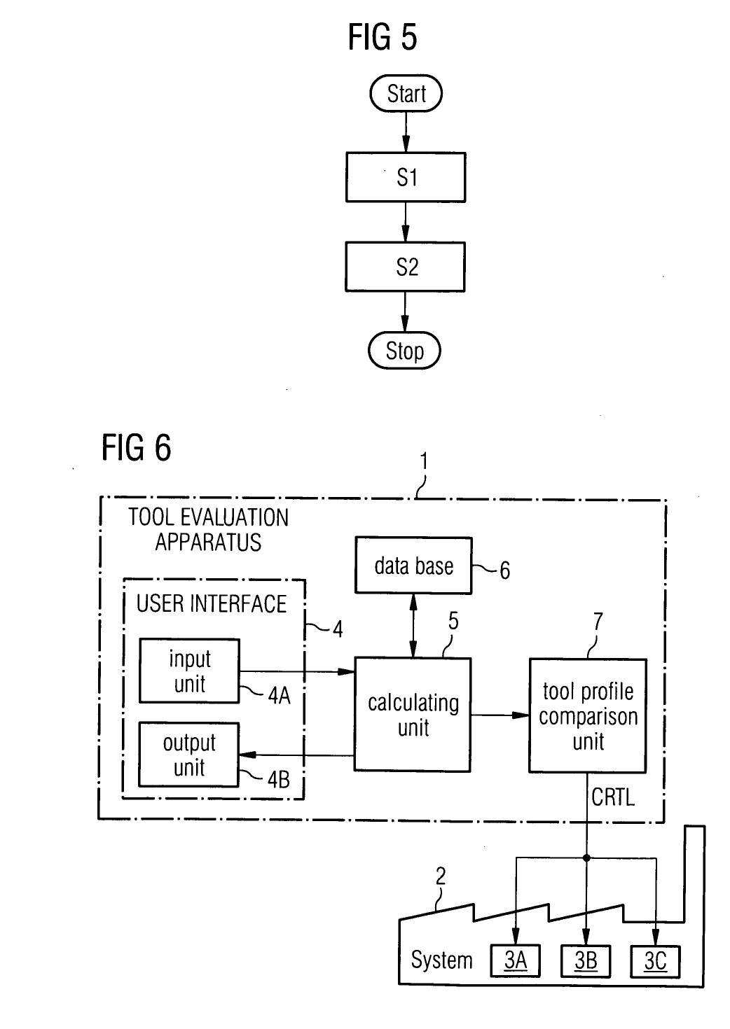

FIG. 5 shows a flowchart of an example embodiment of a method for evaluating a tool used in a system according to an embodiment of the present invention.

In a first step S1 top-level-challenges (TLC) to be met by the tool in at least one life cycle phase of the system to enhance a productivity of the respective system are provided.

The top-level-challenges TLC can be stored in a data base. In an example embodiment a set of top-level-challenges TLC is stored in the data base and depending on the respective tool relevant top-level-challenges TLC can be selected for the different life cycle phases in which the tool can be used. Each top-level-challenge TLC stored in the data base comprises sub-challenges or sub level challenges SLC having a predetermined number of concepts or best practices with different numeric classification values v which can be formed by integer numbers.

In a second Step S2 at least one tool profile of the tool is calculated for the selected top-level-challenges TLCs by way of a configurable function on the basis of the assigned numeric classification values v. In an example embodiment the function is formed by a statistical function which can be configured via an interface.

In an example embodiment not only one tool profile is calculated but at least two or more tool profiles of the same tool or another tool are calculated. Differences between the tool profiles are determined by comparing the calculated tool profiles with each other. In an example embodiment one tool used in the respective system such as a power plant is controlled or adjusted in response to the determined profile difference.

Accordingly the method and apparatus of an embodiment of the present invention can be used not only to evaluate or analyze a tool used in a system but also as a tool control method used for controlling one or several tools such as software tools employed in the technical system.

FIG. 6 shows a block diagram of an example embodiment of a tool evaluation apparatus 1 according to an embodiment of the present invention used for evaluating a tool of a system 2. The system 2 can be formed by a technical system such as an assembly line or a power plant. In the given example the system 2 employs tools in particular software tools 3A, 3B, 3C. These software tools 3A, 3B, 3C are employed in one or several life cycle phases of the system 2 as shown in FIG. 1. Moreover, the software tools 3A, 3B, 3C can be used by users in different domains such as a mechanical or electrical domain.

In the embodiment shown in FIG. 6 the tool evaluation apparatus 1 comprises at least one user interface 4 having an input unit 4A such as a keyboard and an output unit 4B such a display. The user interface 4 is connected to a calculation unit 5 which can be formed by one or several microprocessors. The calculation unit 5 has access to a database 6 which stores top-level-challenges TLC of life cycle phases of the system 2 wherein each top-level-challenge TLC comprises sub-challenges SLC each having a predetermining number of concepts with different numeric classification values v. The calculation unit 5 comprising at least one processor calculates one or several tool profiles of one or several tools 3A, 3B, 3C to be evaluated for selected top-level-challenges TLC by way of a predetermined function on the basis of the numeric classification values v assigned to the sub-challenges SLC of the selected top-level-challenges TLC.

In an example embodiment the assignment of the numeric classification values v to the sub-challenges SLC is performed automatically for example on the basis of a performance history of the respective tool 3.

In an alternative embodiment the assignment of the numeric classification values v is performed by a user via the user interface 4. Furthermore, the selection of top-level-challenges from a group or set of top-level-challenges TLC stored in the database 6 can be performed automatically or manually. The output unit 4B is formed by a display, displaying the tool profiles calculated by the calculation unit 5.

In the embodiment shown in FIG. 6 the tool evaluation apparatus 1 further comprises a tool profile comparison unit 7 which compares at least two calculated tool profiles which each other to derive control signals CRTL for one or several tools 3 employed by the system 2 as indicated in FIG. 6. In the shown embodiment the tool profile comparison unit 7 is connected via control lines to computers or terminals provided within the system 2, wherein the computers execute the respective tool to be evaluated such as tools 3A, 3B, 3C shown in FIG. 6.

In an alternative embodiment of the tool evaluation apparatus 1, the apparatus 1 comprises only a user interface 4 and a calculation unit 5 which has access to a remote database 6 via a network such as the internet. Furthermore, the tool evaluation apparatus 1 according to the present invention does not have in all embodiments a tool profile comparison unit 7 as shown in FIG. 6 but only can have a user interface 4 and a calculation unit 5 formed by at least one processor. In an example embodiment the tool evaluation apparatus 1 is formed by a server connected to an IT-System of the industrial system 2. In an example embodiment the tool evaluation apparatus 1 as shown in FIG. 6 is integrated in each computer provided for executing a software tool of the system 2.

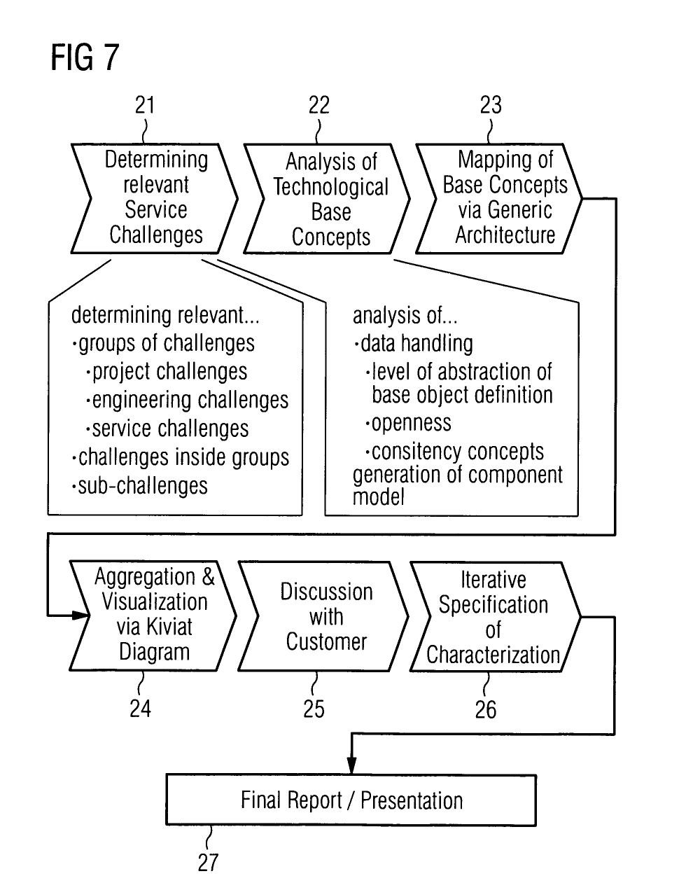

FIG. 7 shows a diagram for illustrating an evaluating workflow for evaluation of a software information tool used by a technical system 2. For providing top-level-challenges (TLC) relevant groups or challenges such as project challenges (P-TLC), engineering challenges (E-TLC) and service challenge (S-TCL) can be determined or selected for the respective tool to be evaluated. In an example embodiment the top-level-challenges (TLC) stored in the database 6 can be selected automatically or manually and corresponding sub-level-challenges SLC can be read from the database 6.

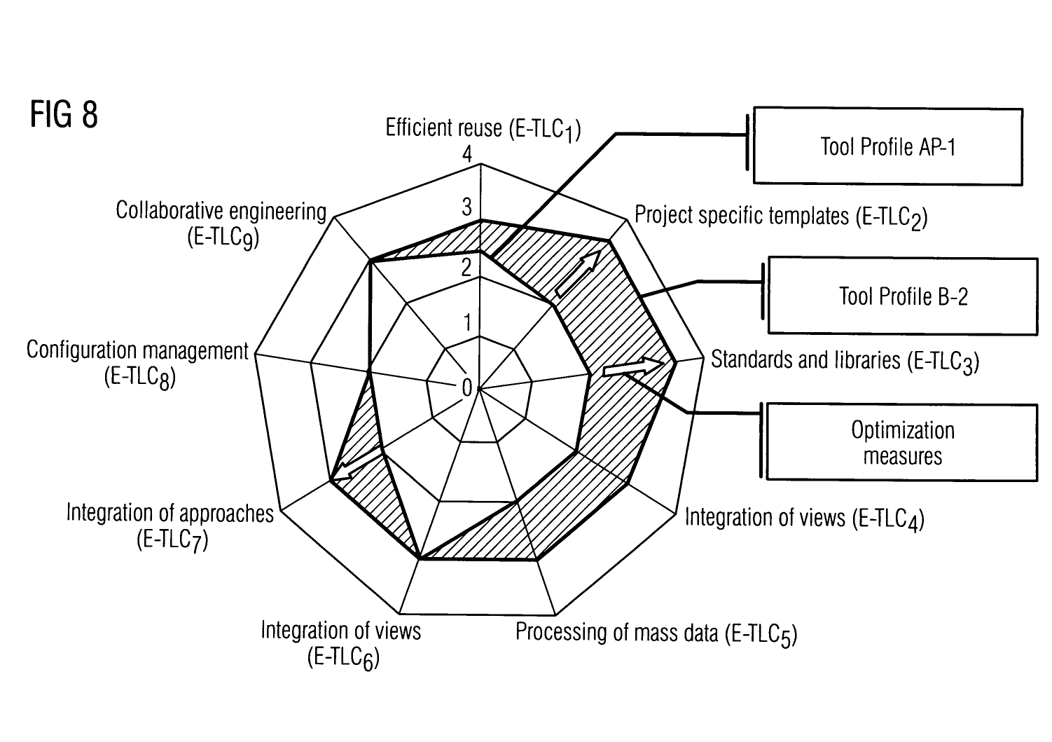

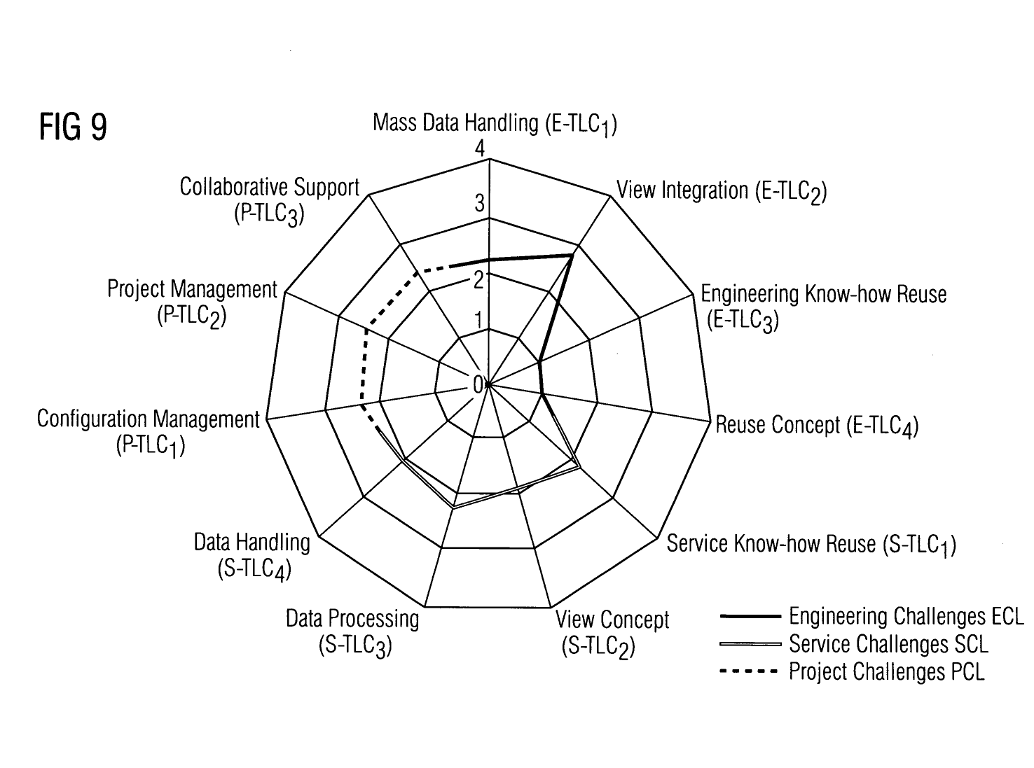

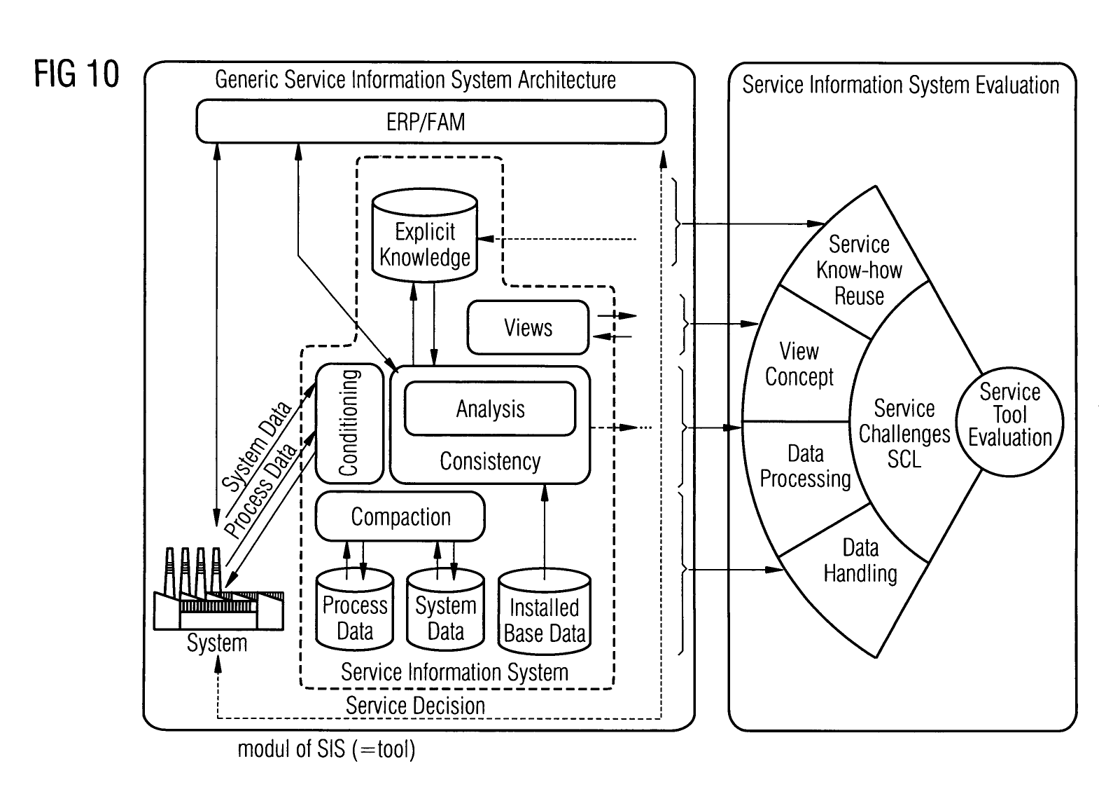

In a further step an analysis of the technological base concepts of the evaluated software tool can be performed. In a following step the mapping of the identified basis concepts can be performed by way of a generic architecture of the software tool such as a service information system SIS shown in FIG. 10. In a further step the aggregation of the calculated characteristic values of the sub-level-challenges SLC by way of statistical functions is executed to calculate a tool profile of the respective software tool. The tool profile can be displayed as a diagram via the user interface 4 to an evaluator or user. The diagram can for example be a kiviat-diagram as shown in FIGS. 8, 9. In an optional further step an information exchange with a tool supplier can follow to optimize the evaluated software tool. A final report on the evaluation results can be presented/generated.

FIG. 8 shows an example of tool profiles calculated for a software tool employed in an engineering life cycle phase of a system 2. In the given example a first tool profile TP-1 and a second tool profile TP-2 of the same tool are calculated for nine different top-level-challenges TLC in the engineering (E) phase of the system 2. The selected top-level-challenges TLC comprise “efficient reuse”, a “project specific template”, “standards in libraries”, “integration of views”, “processing of mass data”, “integration of views”, “integration of approaches”, “configuration management” and “collaborative engineering”. A tool profile TP such as shown in FIG. 8 can be calculated on the basis of numeric classification values v which are assigned to sub-challenges SLC of the top-level-challenges TLC on the basis of concepts or features provided by the respective tool. In this case the tool profile TP indicates a profile of the software tool.

The tool profile such as shown in FIG. 8 can also be calculated on the basis of numeric classification values v by way of a function on the basis of concepts or features of the respective tool which are actually used by users. Such a tool profile is a utilization or usage profile TP of the respective software tool. In the example shown in FIG. 8 the tool profile TP-1 can be a software profile indicating features or concepts offered to a user by the respective software or application whereas the tool profile TP-2 forms a utilization profile of concepts or features actually used by a user. It is possible that the calculated tool profiles TP are compared which each other to calculate a profile difference between the tool profiles as shown in FIG. 8.

An example measure for the profile difference can be the extent of the area or space between the tool profiles wherein the deviation with respect to a specific top-level-challenge TLC such as “efficient reuse” indicate possibilities for optimization measures. In the given example of FIG. 8 the calculated and displayed tool profiles indicate that the respective software tool or tool does not address or cover all desired features or supporting functions which a user desires to use since the software tool profile TP-1 being a measure of the features offered by the respective software tool lies within the tool profile TP-2 showing a desired utilization, i.e. a usage tool profile. The difference between the tool profiles show where optimization measures are possible to improve the support of the respective software tool to achieve the selected top-level-challenges TLC and therefore increasing the productively of the whole system 2.

FIG. 9 shows a further example of a tool profile TP as calculated by the method according to an embodiment of the present invention. In the given example of FIG. 9 several top-level-challenges TLC are selected from the database wherein the top-level-challenges TLC are chosen from different life cycles of the system 2. In the given example some top-level-challenges TLC such as “mass data handling”, “view integration”, “engineering know how reuse”, “reuse concept” are selected from top-level-challenges TLC of the engineering phase E whereas other top-level-challenges TLC are selected from other life cycle phases such as the service top-level-challenges TLCs “Service know how reuse”, “view concept”, “data processing”, “data handling” or from other life cycle overspanning project-top-level-challenges P-TLC such as “configuration management”, “project management” and “collaborative support”. The calculated tool profile TP as shown in FIG. 9 shows a characteristic of a tool in achieving top-level-challenges TLC of different life cycle phases of the system 2 and can be used for focussed development and improvement of the respective tool.

FIG. 10 shows a generic service information system architecture as an example of a reference model or reference tool architecture for an assignment of numeric classification values to improve or to increase an objective assignment of such values. The generic service information system architecture as a reference model can also be stored in the database 6. It is possible to compare the set of challenges used for the challenge based evaluation of a service information system SIS forming a software tool with a dedicated predetermined generic architecture as a reference model as shown in FIG. 10. The reference model can be used as a template and can be generated as part of the evaluation workflow thereby simplifying the process. Evaluation of the service information system SIS as a software tool is formalized by comprehensibly mapping sub-challenges SLC of the industrial service business to generic components. By comparing the component module of the system to the generic architecture the evaluating user is supported in selecting relevant challenges for certain components. Therefore, an evaluation of a tool becomes reproducible as a consequence of the systematic and structured mapping of sub-challenges SLC thereby resulting in a gain of objectivity to the evaluation outcome which can be formed by a diagram or a report.

For the example generic architecture as shown in FIG. 10 a set of requirements can be defined which can be evaluated for all kinds of industrial businesses. In particular this requirements are the challenges of the respective business field which are mapped to defined areas of the generic architecture. Sub-challenges are mapped to components of the generic architecture and can include a description of functions and data processed by the respective tool. The reference model or architecture can form a normative model and must not include all components or units of the respective system 2. The generic architecture shown in FIG. 10 can be provided to a designer of the respective software tool such as a service information system SIS or to a user of the respective software tool, i.e. as a user of a service information system SIS. Further, an example addressee is an evaluator, i.e. a user evaluating a tool, in particular a software tool of a system in which the respective tool is employed.

Results of a service information system SIS evaluations a tool profile as shown in FIG. 9 can help a software tool supplier to specifically identify and evaluate requirements of future versions of its software tool. The tool profile of the existing service information system SIS as a software tool sheds light on the level of support the respective information tool provides when facing the challenges as the industrial service business. Further it is possible to compare versions of the same software tool such as a service information system SIS or with software tools of competing providers to identify potential optimization measures. In the given example of FIG. 9 the selected top-level-challenges S-TLC of the life cycle phase “service” comprise “service know how reuse”, “view concept”, “data processing” and “data handling”. By using and parameterizing the service information system SIS a user is able to actively put his knowhow into the respective system. This can be expressed as the top-level-challenge TLC “service know how reuse”.

The data processing considered by the top-level-challenge “data processing” e.g. takes care of data conditioning, consistency checks and analysis of information data of the respective system 2 such as a power plant.

Further, a top-level-challenge TLC of the service life cycle is “data handling”. The data provided by different data bases can be contained in the reference architecture as shown in FIG. 10.

Between the challenges posed by the industrial service business and the requirements implemented by a service information system SIS as a software tool often exists a gap. The method and apparatus according to at least one embodiment of the present invention helps to close such a gap. Mapping key concepts of challenges and requirements of software tools such as a service information system SIS can be integrated. A generic architecture for a software tool such as a service information system SIS shown in FIG. 10 applies a formalization evaluation process by providing a reference model of an service information system SIS in an industrial service. This approach can be extended to other life cycle phases. Accordingly interrelated challenges between engineering, commissioning, service execution, operation and modernisation can be identified and considered with reference to the service execution as well as to prior and later life cycle phases of the system 2. The method and apparatus of the present invention enables a productivity check of industrial software tools used in the same or different life cycle phases of a system.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for evaluating a tool used in a system, the method comprising:
(a) providing top-level-challenges to be met by the tool in at least one life cycle phase of the system to enhance a productivity of the system, each of the top-level-challenges including sub-challenges, each having a number of concepts with different numeric classification values; and
(b) calculating at least one tool profile of the tool for the top-level-challenges, by way of a function, on the basis of numeric classification values assigned to the sub-challenges of the top-level-challenges.

2. The method according to claim 1, wherein the numeric classification values are formed by integer values which are assigned to the sub-challenges on the basis of concepts provided by the tool or on the basis of concepts of the tool used by a user.

3. The method according to claim 1, wherein the function is formed by a statistical function of the numeric classification values.

4. The method according to claim 3, wherein the statistical function is calculating an average value on the basis of the numeric classification values.

5. The method according to claim 1,
wherein at least one further tool profile of the same or another tool is calculated and a profile difference between the calculated tool profiles is determined by comparing the tool profiles.

6. The method according to claim 1, wherein the numeric classification values are assigned using a reference tool architecture of the tool stored in a database.

7. The method according to claim 1,
wherein the tool is formed by a software information tool or a hardware tool.

8. The method according to claim 1,
wherein the system is formed by an industrial system comprising as life cycle phases
an engineering phase,
a commissioning,
an operation phase,
a service phase and
a modernization phase.

9. The method according to claim 8,
wherein for each life cycle phase of the system, at least one top-level-challenge is stored in a database.

10. The method according to claim 9,
wherein a group of top-level-challenges, to be met by the tool, are selected from the top-level-challenges stored in the database.

11. The method according to claim 5,
wherein at least one tool used in the system is controlled in response to a determined profile difference.

12. The method according to claim 1,
wherein the tool profile is calculated on the basis of:
a tool requirement specification,
a tool design specification,
a tool prototype specification or
a tool release specification.

13. The method according to claim 1,
wherein the method is performed by executing instructions of a computer program stored on a data carrier.

14. An apparatus for evaluating a tool used in a system, the apparatus comprising:
(a) means for providing top-level-challenges to be met by the tool in at least one life cycle phase of the system to enhance a productivity of the system, each of the top-level-challenges including sub-challenges, each having a number of concepts with different numeric classification values; and
(b) means for calculating at least one tool profile of the tool for the top-level-challenges, by way of a function, on the basis of numeric classification values assigned to the sub-challenges of the top-level-challenges.

15. An apparatus for evaluating a tool used in a system, the apparatus comprising:
a database to stores top-level-challenges of life cycle phases of the system, wherein each of the top-level-challenges includes sub-challenges, each having a number of concepts with different numeric classification values; and
a processor to calculates at least one tool profile of the tool for at least a selected one of the top-level-challenges, by way of a function, on the basis of numeric classification values assigned to sub-challenges of the at least one selected top-level-challenge.

16. The apparatus according to claim 15, further comprising:
a user interface to select the at least one top-level-challenge, to assign numeric classification values and to display the at least one tool profile.

17. The apparatus according to claim 15, further comprising:
a configuration interface to configure the function.

18. A system, comprising:
a system life cycle including at least one life cycle phase and using at least one tool in one of the at least one life cycle phases, wherein for each life cycle phase at least one top-level-challenge is stored in a database, each top-level challenge including sub-challenges, each including a number of concepts with different numeric classification values which are assigned to the respective sub-challenges for calculation of tool profiles to evaluate tools used in the at least one life cycle phases of the system.

19. The system according to claim 18,
wherein the system includes an industrial system as a main domain having several subdomains.

20. The system according to claim 19,
wherein the subdomains comprise
an electrical subdomain,
a mechanical subdomain,
an automation subdomain and
a civil engineering subdomain.
